(19) United States
(12) Patent Application Publication
(10) Pub. No.: US 2014/0161234 A1
(43) Pub. Date: Jun. 12, 2014

(54) ALIGNMENT SYSTEM

(71) Applicants: Raynold Lee Saar, Marietta, GA (US); Michael R. Razzano, (US)

(72) Inventors: Michael R. Razzano, Marietta, GA (US); Raynold Lee Saar, Marietta, GA (US)

(21) Appl. No.: 14/096,492

(22) Filed: Dec. 4, 2013

Related U.S. Application Data
(60) Provisional application No. 61/734,033, filed on Dec. 6, 2012.

(51) Int. Cl. G21K 1/02

(52) U.S. Cl. CPC G21K 1/02
USPC 378/147

(57) ABSTRACT

Disclosed is an alignment indication system for an X-ray to align a sensor with X-rays emitted from a collimator that includes a conductive surface and two contacts that abut the conductive surface when an alignment ring holding the sensor is properly aligned with the collimator to activate an indicator such as a light when the sensor is properly aligned.

### CROSS REFERENCE TO RELATED APPLICATIONS

This application claims the benefit of U.S. Provisional Application No. 61/734,033, filed Dec. 6, 2012, under 35 USC 119(e), which is hereby incorporated by reference.

### BACKGROUND

Conventional round collimator cones emit radiation from X-ray devices in a spreading pattern. Only approximately 10% of the emitted radiation hits a conventional sized sensor/X-ray film used to take dental X-ray images. Many photons end up scattered into the patient's tissue or reflected back to the sensor or film as noise that may compromise the image resolution of the X-ray image created.

One known solution to this issue is to use a collimator that masks and shields the emitted X-ray radiation so that the radiation emitted from the collimator is only slightly larger than the size of the sensor or X-ray film.

One known problem with a masked collimator is that any misalignment between the collimator and the sensor or X-ray film results in cone-cutting, where the entire surface of the sensor or film is not exposed to the emitted radiation, which can compromise the image created as desired anatomical features may not be imaged.

There is a need for systems to accurately align sensors and film with masked collimators to promote the use of masked collimators to reduce patient exposure to unnecessary radiation emissions.

### BRIEF DESCRIPTION OF THE DRAWINGS

FIG. 1 is a perspective view of a collimator adaptor and alignment ring assembly.

FIG. 2 is a side elevational view of the FIG. 1 collimator adaptor.

FIG. 3 is a front elevational view of the FIG. 2 collimator adaptor.

FIG. 4 is a front elevational view of the FIG. 1 alignment ring.

FIG. 5 is a side elevational view of the FIG. 4 alignment ring.

FIG. 6 is an electrical schematic of an alignment indication system.

FIG. 7 is an electrical schematic of an alternative embodiment of an alignment indication system.

FIG. 8 is a side elevational view of a collimator and alignment ring separated.

FIG. 9 is a side elevational view of a collimator and alignment ring showing the alignment ring aligned with the collimator.

FIG. 10 is a side elevational view of a collimator and alignment ring showing the alignment ring misaligned with the collimator.

FIG. 11 is a perspective assembly view of an X-ray source with a collimator and an alignment ring with a receptor holder and digital sensor.

### DETAILED DESCRIPTION

Reference will now be made to certain embodiments and specific language will be used to describe the same. It will nevertheless be understood that no limitation of the scope of this disclosure and the claims are thereby intended, such alterations, further modifications and further applications of the principles described herein being contemplated as would normally occur to one skilled in the art to which this disclosure relates. In several figures, where there are the same or similar elements, those elements are designated with the same or similar reference numerals.

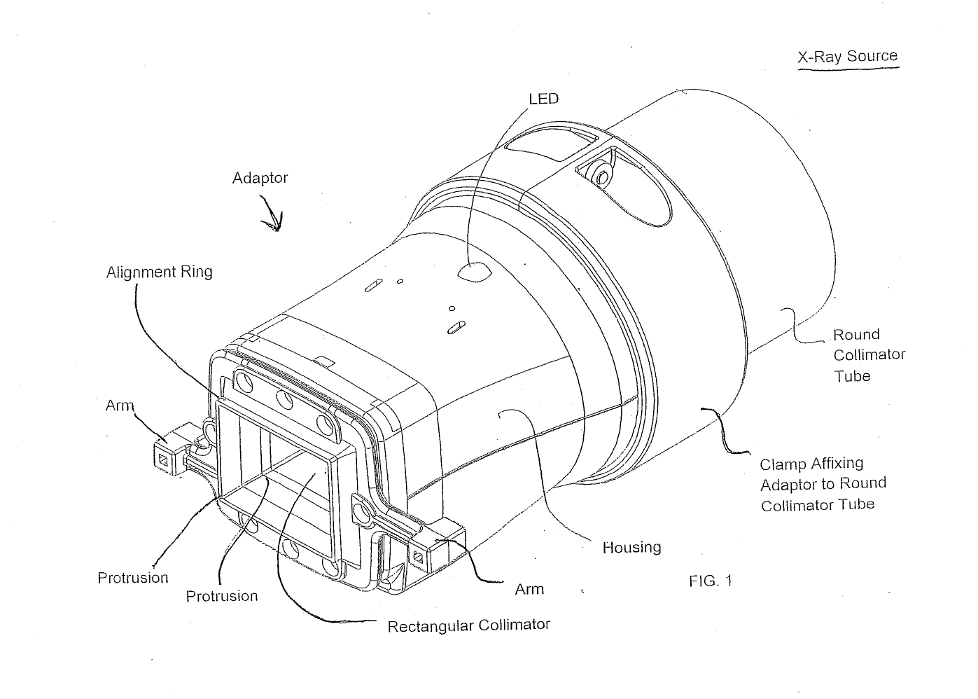

Referring to FIG. 1, a collimator adaptor is illustrated. The collimator adaptor includes a round collimator tube that is attached to an X-ray source as known in the art.

The adaptor includes a clamp affixing the adaptor to the round collimator tube and a rectangular collimator surrounded by a housing. The illustrated adaptor changes the emitted X-ray profile from a round profile to a rectangular profile that may match the size and geometry of a target sensor or X-ray film (not illustrated) aligned with the rectangular collimator. In this regard, an alignment ring is affixed to the end of the housing. The alignment ring includes arms that may be used to hold a receptor holder (not illustrated) that holds an X-ray film or a sensor aligned with the rectangular collimator. The alignment ring includes protrusions that extend into the adaptor housing and serve to help align the alignment ring with the rectangular collimator.

It should be understood that the illustrated collimator could be directly incorporated into an X-ray device thereby optionally omitting the round collimator tube and clamp affixing the adaptor to the round collimator tube. In one embodiment, the collimator tube may be permanently affixed to an X-ray generator and in other embodiments the collimator may be detachable from the X-ray generator such as removing the clamp in the illustrated embodiments.

The adaptor also includes an LED mounted on the exterior of the housing. The LED is configured to illuminate when the alignment ring is affixed to and aligned with the housing. The operation of the LED is described below.

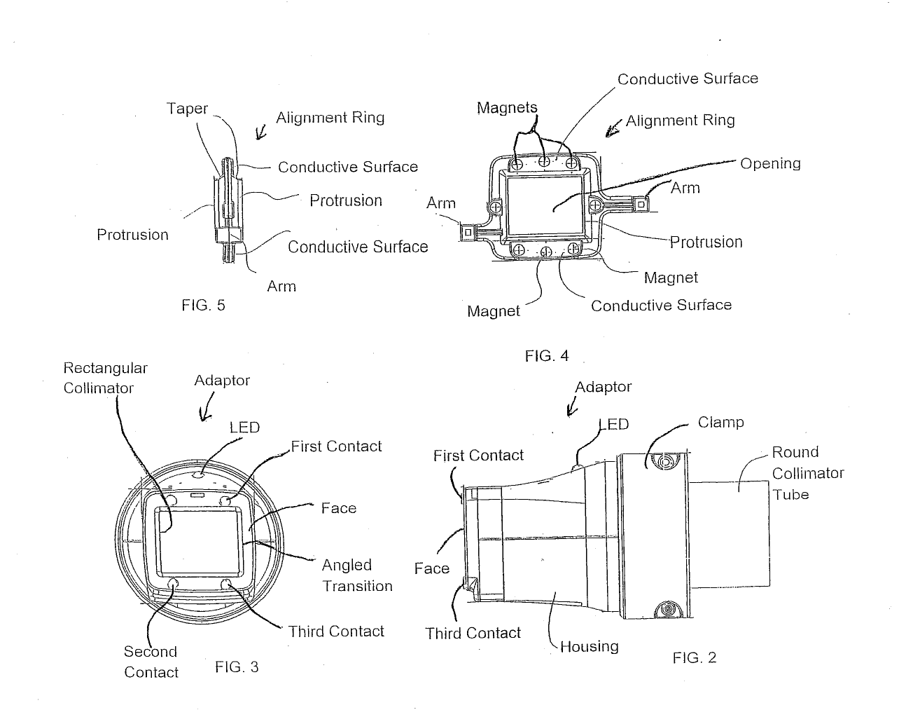

Referring now to FIGS. 2-3, the adaptor is illustrated. The adaptor includes a first, second and third contact on the face of the housing where the alignment ring mounts. The adaptor also includes an angled transition between the face of the housing and the rectangular collimator. The external surface of the face of the housing may be metallic or constructed from a magnetic material. Alternatively, the external surface of the face of the housing may be a coated metallic or magnetic material.

The first, second and third contacts on the face of the housing may protrude beyond the face of the housing a minimal amount, for example, between 10 and 50 thousandths of an inch. The first, second and third contacts may optionally be biased to protrude with a small biasing force that forcibly pushes the contacts against the alignment ring when the alignment ring is mounted. The first, second and third contacts may be configured to move such that their outer surface is substantially flush with the face of the adaptor or collimator. The leading surface of the first, second and third contacts may be substantially flat or may be slightly domed.

Referring now to FIGS. 4-5, the alignment ring is illustrated. The alignment ring includes a plurality of magnets around the periphery, a protrusion on each side with a tapered transition between the alignment ring and each protrusion. The tapered transition and protrusion are constructed and arranged to align with and fit within the adaptor housing to align the opening in the alignment ring with the rectangular collimator. In this regard, the tapered transition and the angled transition may be constructed and arranged to mate against each other. The magnets on the alignment ring may engage a metal or magnetic material located either in the housing of the adaptor or on the surface of the face of the housing.

The magnets may optionally be recesses below the surface of the alignment ring such that the magnets do not directly contact the face of the collimator housing when the alignment ring is attached to the collimator housing. The depth of recessing may optionally be used to vary the effective holding force between the alignment ring and the collimator.

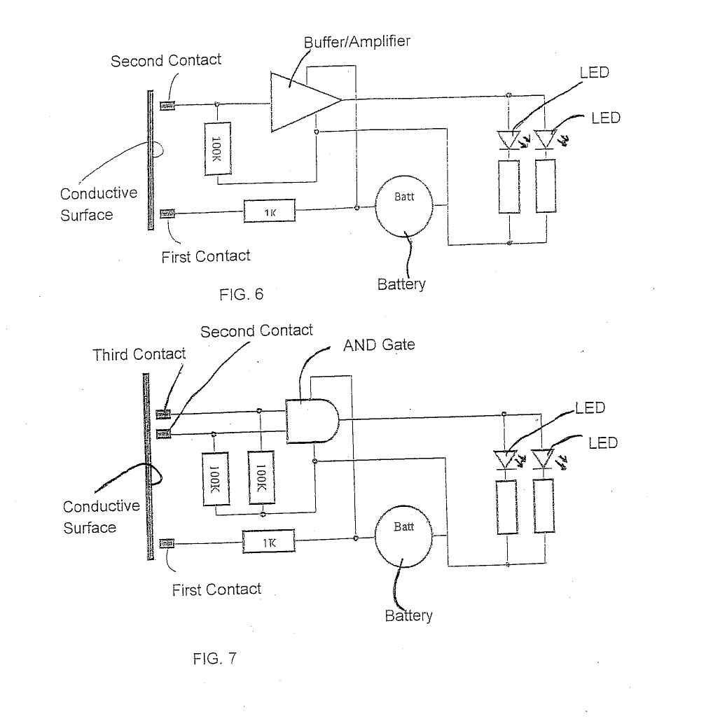

Referring now to FIG. 6, an electrical schematic of an alignment detection system is illustrated. The electrical schematic includes a first and second contact as shown on the housing of the adaptor and a conductive surface representing the illustrated surface of the alignment ring. The circuit includes a battery, a 100 kΩ resistor, a 1 kΩ resistor, a buffer/amplifier and one or more LEDs. The circuit operates when the conductive surface on the alignment ring completes a circuit between the first and second contact on the housing of the adaptor. The current in the battery flows through the 1 kΩ resistor, through the conductive surface and to the buffer/amplifier. The buffer/amplifier is powered by the battery and provides an output signal to the LED to illuminate the LED when there is contact between the first and second contact and the conductive surface on the alignment ring. Use of the buffer/amplifier provides a consistent output voltage to power the LEDs.

Referring now to FIG. 7, an alternative circuit is illustrated including a first, second and third contact and utilizing an AND gate rather than buffer/amplifier to power the LED's. The illustrated circuit operates similarly in that the conductive surface on the alignment ring completes the circuit between the first, second and third contacts on the face of the adaptor. When contact is made, current flows from the battery through the 1 kΩ resistor through the conductive surface and to the first and second contacts to the AND gate. When both the first and second contacts receive power through the conductive surface the AND gate operates to send a voltage to the LED to illuminate the LEDs.

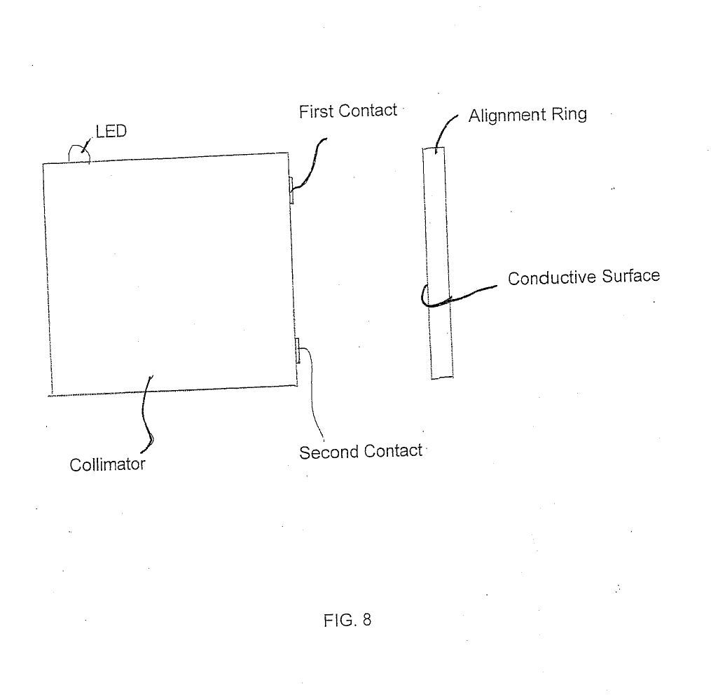

Referring now to FIG. 8, an illustrative collimator is shown with an illustrative alignment ring spaced apart from a first and second contact on the collimator.

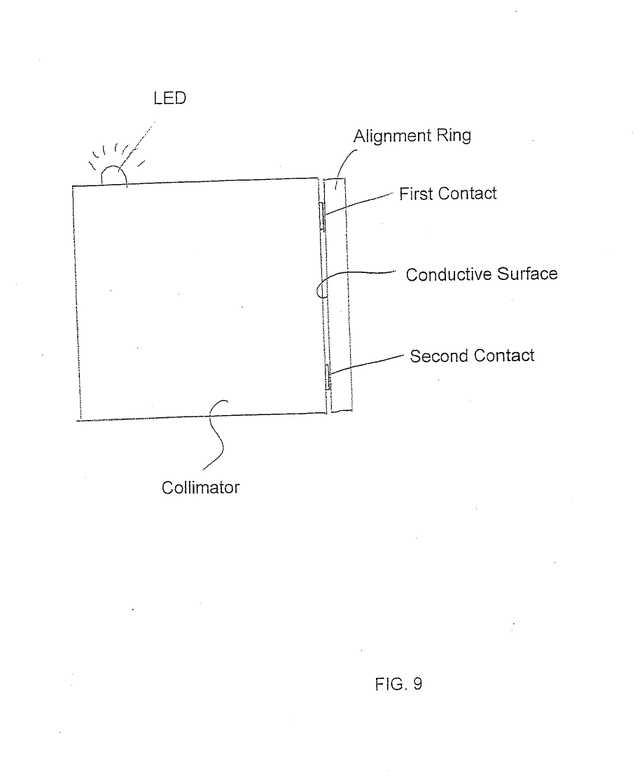

Referring now to FIG. 9, the collimator and alignment ring are shown in aligned in contacting orientation with the conductive surface in contact with the first and second contacts completing the circuit such as that illustrated in FIG. 6 such that the LED is powered and generates a visible light.

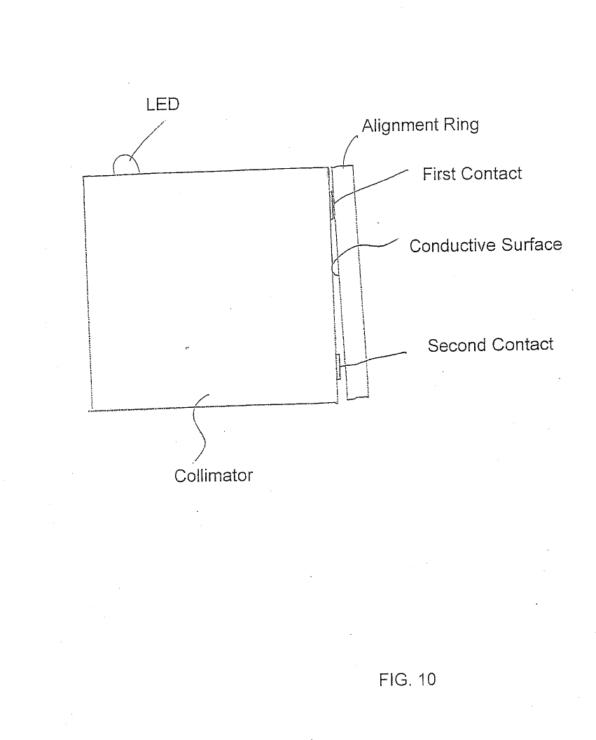

Referring now to FIG. 10, the same system is illustrated with the alignment ring out of alignment with the collimator. The first contact is in contact with the conductive surface on the alignment ring; however, the second contact is not in contact with the conductive surface on the alignment ring such that the LED is not illuminated.

The rectangular collimator serves as a means for focusing X-rays produced by the X-rays source and may decrease scatter radiation and/or absorb radiation thereby lowering X-rays emitted outside of the rectangular collimator. While a rectangular collimator is shown, other collimators can be used including those with a square or round cross sectional shape as a few additional non-limited examples.

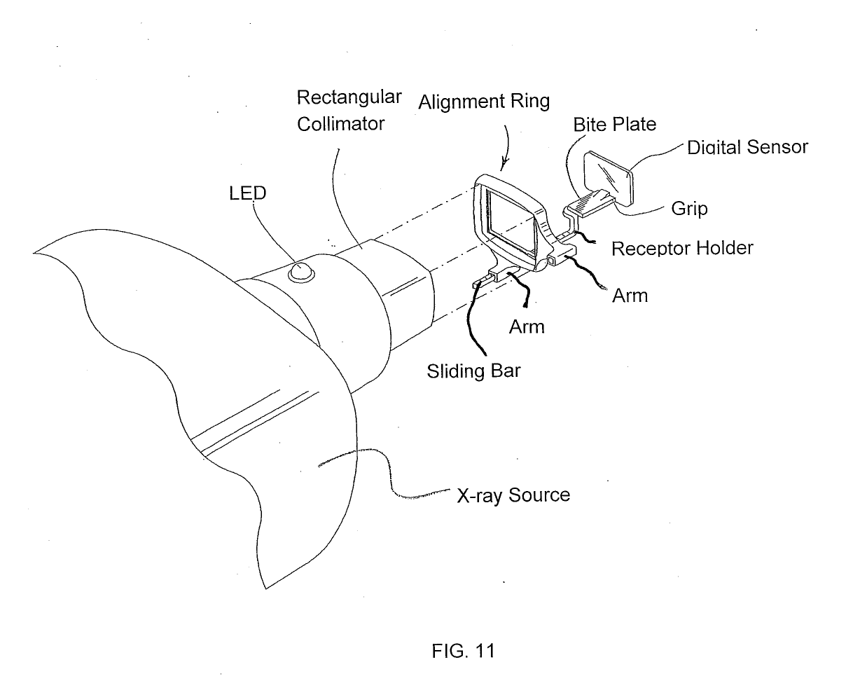

Referring to FIG. 11, an X-ray system is illustrated including a X-ray source, a rectangular collimator, an alignment ring and a receptor holder holding a digital sensor. The rectangular collimator adapter defines the rectangular collimator tunnel for emitting X-rays that substantially conform to the size and shape of the digital sensor (or film, if used instead). The alignment ring defines an opening corresponding to the rectangular collimator and includes arms for receiving a sliding bar of the receptor holder. The receptor holder has a holder end that includes a bite plate and a grip that is operative to hold an image receptor such as X-ray film or digital charged coupled device (CCD) sensor as a few non-limiting examples. The bar on the receptor holder may be adjustable through the arm to adjusting the distance between the end of the receptor holder and the alignment ring. In the illustrated embodiment the arm has a square cross sectional shape to match the hole in the arms.

While the disclosure has been illustrated and described in detail in the drawings and foregoing description, the same is to be considered as illustrative and not restrictive in character, it being understood that only the preferred embodiments have been shown and described and that all changes and modifications that come within the spirit of the disclosure are desired to be protected.

We claim:

1. A system comprising:
a collimator constructed and arranged to filter a stream of X-rays so that only those traveling substantially parallel to a specific direction pass through the collimator;
an alignment ring constructed and arranged to abut the collimator and hold a sensor aligned with the collimator such that the sensor is positioned downstream of the collimator in the specific direction such that X-rays filtered by the collimator strike the sensor, wherein the alignment ring is constructed to hold a sensor that conforms to the size and shape of the X-rays filtered by the collimator with the sensor held substantially aligned with the stream of X-rays emitted by the collimator;
a conductive surface on either the alignment ring or the collimator;
a first contact on either the collimator if the conductive surface is on the alignment ring or on the alignment ring if the conductive surface is on the collimator;
a second contact on either the collimator if the first contact is on the collimator or on the alignment ring if the first contact is on the alignment ring, wherein the first and the second contacts are arranged to abut the conductive surface when the alignment ring abuts the collimator and wherein the first and second contacts are spaced apart from each other; and
an electric circuit electrically connected to the first and second contacts, wherein the electric circuit is constructed and arranged to produce an indication when both the first and second contacts abut the conductive surface.
